(19) United States
(12) Patent Application Publication
(10) Pub. No.: US 2012/0297939 A1
(43) Pub. Date: Nov. 29, 2012

(54) Handle-Driven Torque Transfer Wrench having Pivotable Head

(76) Inventor: Joseph Spata, New Milford, NJ (US)

(21) Appl. No.: 13/478,243

(22) Filed: May 23, 2012

Related U.S. Application Data
(60) Provisional application No. 61/489,089, filed on May 23, 2011.

(51) Int. Cl. B25B 23/142; B25B 13/46; B25B 17/00

(52) U.S. Cl. 81/478; 81/54; 81/57.29; 81/57.39

(57) ABSTRACT

Disclosed is a torque transfer device, comprising a body section, a rotary head section and an internal driveshaft within the body section for coupling rotational input through the body to the head section at an angle with respect to the drive direction. The body section comprises a rotational drive input that connects to an internal driveshaft. The body section terminates, allowing the driveshaft to continue into a universal pivot joint, which further connects to the head section having an internal rotary ratchet transmission and socket-accepting inner portion. As the input is rotated, the driveshaft rotates the ratchet head, providing a tool that allows directional variation with regard to input and output torque transmission. The universal joint allows the head section to be further rotated with respect to the body section for improved torque input onto fastener heads in enclosed or shrouded locations.

### CROSS REFERENCE TO RELATED APPLICATION

This application claims the benefit of U.S. Provisional Application No. 61/489,089 filed on May 23, 2011, entitled “Powerwrench.”

### BACKGROUND OF THE INVENTION

1. Field of the Invention

The present invention relates to ratcheting box wrenches, spanners and wrench tools for inputting torque onto a fastener head within confined spaces having minimal clearance for tool rotation. More specifically, the present invention pertains to a ratcheting box wrench having a handle drive mechanism that allows rotational input through the handle to affect a rotation at the wrench working end, between which is a universal joint that allows misalignment of the wrench head with its shaft body for improved access to fastener heads within confined areas.

Box wrenches and ratcheting mechanisms are well known in the art of mechanical and automotive tools. These devices allow a user to obtain purchase on a fastener nut and apply a torque thereto for the purposes of driving or loosening a fastener. Ratcheting box wrenches employ a rotary ratchet mechanism within the head of the tool, allowing torque to be applied to the head of a fastener placed within the mechanism interior by way of rotation of the tool handle. The ratchet mechanism transmits torque in a single rotational direction, while also allowing free rotation in an opposite direction for the user to reciprocate the ratchet handle back to its starting position, wherein torque is applied during a portion of a full rotation of the handle and returned to its initial position without disengaging from the fastener. These devices are well suited for their intended requirements and are well known to those skilled in the art. They provide a means of applying torque to the head of a fastener during a partial rotation of the tool, while allowing the tool handle to be returned to its starting position without disengaging the fastener head. There exists a need, however, for a tool that allows the ratcheting wrench tool to apply the same rotation at its working end while its handle end remains stationary. Further still, there exists a need for such a tool to be insertable into extremely confined areas and allow a user to secure to and apply a torque to a fastener at an angle with regard to the shaft of the tool, facilitating purchase of a fastener around a corner or in a blind location with respect to the user.

Offset or handle-driven box wrench tools are other devices that are well known in the art, wherein rotation of the tool handle establishes a rotation of the working end of the wrench. These devices employ many different internal mechanisms for the purposes of driving a fastener through rotation of the handle or via pneumatic action. These mechanisms largely include internal worm gears and spur gears that allow perpendicular transmission of torque from the handle to the head of the tool. As with standard ratcheting wrench tools, these devices are well suited for their particular requirements and allow torque transmission through the tool handle and to a fastener within confined areas. However, there exists a need for an improvement to such devices, wherein a universal joint along the line of transmission allows the working end to pivot with respect to the handle for torque application in even more confined and blind areas.

The present invention therefore relates to an improvement to existing ratcheting box wrenches and handle-driven wrenches, wherein a handle-driven wrench is disclosed having a pivoting head portion to permit torque transmission to a fastener at an angle with respect to the drive handle portion. A universal joint along the drive shaft of the wrench allows rotation of the tool head with respect to the handle, wherein off angle and non-perpendicular torque application is possible. The goal is to provide a tool with increased capacity for reaching and torquing bolts and other rotary fasteners in extremely confined areas, particularly modern car engine bays wherein open access is limited by engine accessories, covers and sub-systems.

2. Description of the Prior Art

Devices related to ratcheting tools and those that allow torque transmission through the handle of the tool have been disclosed in the prior art. These include patented devices and those disclosed in published patent application publications. These devices relate to perpendicular drive wrenches and various mechanisms therefor. These devices fail to disclose or contemplate the use of a central drive shaft that incorporates a pivotable universal joint that alters the torque transmission path with respect to the handle and ratcheting head directions. The devices deemed most relevant to the present disclosure are herein described for the purpose of highlighting the differentiating features or the present invention.

Specifically, U.S. Pat. No. 6,718,850 to Huang describes an improvement to a socket wrench forming a torque transfer mechanism having a rotary rod connected to a bevel gear that is further meshed with a ring gear in the wrench head. The device allows perpendicular torque transfer without changing the outer profile of the socket wrench. While offering an internal drive mechanism similar to that of the present invention, the present device improves the ability of a wrench to access confines bolts and fasteners by the inclusion of a universal joint, which allows offset torque transmission along the driveshaft of the wrench.

Further, U.S. Pat. No. 7,340,981 to Walter discloses an angled and offset drive ratchet extension comprising a socket driver, a rotatable drive shaft, a first direction changing transmission and a second direction changing transmission. The device allows a user to engage the first direction changing transmission at a given angle or offset from the second transmission, wherein input torque is transmitted at a different angle than that of the output in the ratchet head. The tool offers an offset and an extension such that an external ratchet may send torque to the tool's working end at various standoff positions and input angles. While providing a tool that allows offset input, the Walter device fails to disclose a tool that allows angular adjustment of the ratchet head with respect to his body section. The Walter device alters the angle and position of the input end of the tool, while the present invention alters the output torque direction with regard to its central driveshaft.

A plurality of similar drive wrenches are disclosed in the prior art, which specifically relate to the internal means of torque transmission between a rotational handle input and a perpendicular rotational output. These devices disclose varying embodiments and designs for orthogonal drive mechanisms that allow a user to twist a handle input or internal driveshaft to affect a rotation of an inner ring gear or similar rotary element within the head of the tool. These devices fail to contemplate a universal joint within the body of the tool, wherein the driveshaft is permitted to transmit torque at an angle with respect to its input direction. The present invention provides such a tool, wherein the head of the tool is therefore pivotable about the universal joint without disconnected the means of torque transmission. This facilitates the driving of fastener heads in extremely confined and hidden locations, wherein perpendicular positioning of the tool is not possible due to space limitations, and further rotation of a standard wrench handle is not efficient or possible. It is submitted then, that the present invention is substantially divergent in design elements from the prior art, and consequently it is clear that there is a need in the art for an improvement to existing torque transmission wrench devices. In this regard the instant invention substantially fulfills these needs.

### SUMMARY OF THE INVENTION

In view of the foregoing disadvantages inherent in the known types of rotatable torque transfer wrenches now present in the prior art, the present invention provides a new torque transmission tool having an angular or rotatable head, wherein the same can be utilized for providing convenience for the user when driving rotary fasteners in blind and confined spaces wherein orthogonal torque application is not feasible.

It is therefore an object of the present invention to provide a new and improved torque transfer wrench device that has all of the advantages of the prior art and none of the disadvantages.

It is another object of the present invention to provide an improved torque transfer wrench that facilitates rotation of a fastener head within confined and blind areas, particularly in automotive applications wherein fastener access and engine bay space is limited.

Another objects of the present invention is to provide an improved torque transfer wrench having a rotatable head working end, wherein the head provides connection to a rotary fastener and a torque output means. The head is rotatable about a universal joint that allows the input torque to be transmitted through two interlocked segments of the tool driveshaft that may be misaligned, allowing the tool output torque to be at varying angles with respect to the input torque direction.

Another objects of the present invention is to provide an improved torque transfer wrench that includes an input having a female input means, allowing a separate wrench to apply torque driveshaft of the present device.

Another objects of the present invention is to provide an improved torque transfer wrench that may include an electric, pneumatic or manual drive input means, and may further include a torque measuring means within the handle of the device to allow a specified torque limit through the driveshaft.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2 shows a perspective view of the present invention being utilized in conjunction with a ratchet tool input.

FIG. 3 shows a cross section view of an embodiment of the internal ratchet drive means of the present invention.

FIG. 4 shows a cross section view of another embodiment of the internal ratchet drive means of the present invention.

FIG. 5 shows a cross section view of the universal joint and drive shaft of the present invention.

FIG. 6 shows a cut-away view of an embodiment of the tool handle, wherein a spring-type torque limiter is provided for applying measured levels of torque through the tool.

### DETAILED DESCRIPTION OF THE INVENTION

Reference is made herein to the attached drawings. Like reference numerals are used throughout the drawings to depict like or similar elements of the torque transmission wrench. For the purposes of presenting a brief and clear description of the present invention, the preferred embodiment will be discussed as used for applying torque to a rotary fastener in confined and blind locations. The figures are intended for representative purposes only and should not be considered to be limiting in any respect.

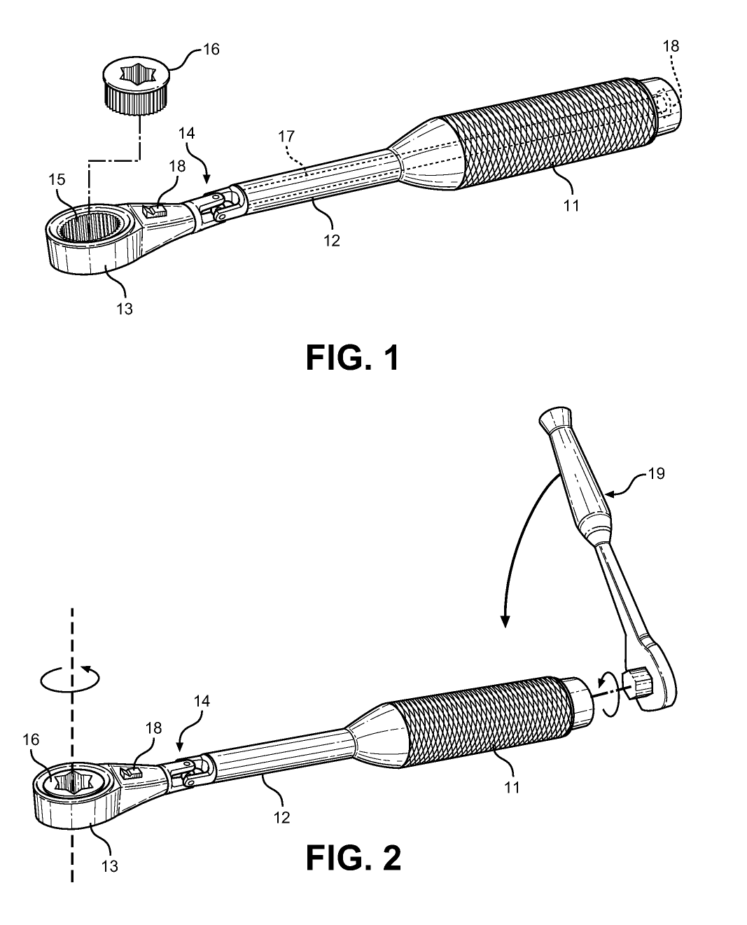

Referring now to FIG. 1, there is shown a perspective view of the torque transmission wrench tool of the present invention, wherein a socket 16 is shown in an exploded configuration with respect to the head 13 of the tool. The wrench itself comprises an elongated body having a handle section 11 and a ratcheting head section 13. The handle end 11 includes a torque input 18 at its proximal end, wherein another input tool, such as a ratchet or screw driver, applies torque through the input in the handle end 11 and through a central driveshaft 17 running through the handle 11. The driveshaft is a rotatable member centrally located within the handle 11 that terminates at a universal joint 15. The universal joint 15 is a coupling along the driveshaft just before the head and ratchet transmission elements of the tool head 13, and allows the head 13 to be oriented at an angle with respect to the driveshaft length direction. This allows the head 13 to be rotated with respect to the handle 11 for improving access to rotary fastener heads that may be situated in confined, blind, or otherwise cramped quarters, wherein a straight ratchet may be unable to affix thereto and introduce a tightening or loosening torque.

The universal joint is external to the handle end and is positioned at the end of the handle neck region 12. When accessing blind fasteners or ones that are not readily accessible, the head 13 may be rotated while maintaining connectivity between the driveshaft input and the head rotating output 15. The output 15 is an internally rotating gear 15 that accepts a corresponding socket 16, wherein the socket is adapted to secure against the head of a fastener for driving or loosening purposes. Within the head 13 is a ratcheting and torque transfer mechanism that transforms the rotation of the driveshaft into a rotation of the rotating socket gear 15. The mechanisms may include a bevel gear or worm gear, and further include a ratchet direction pawl that determines the drive and ratchet directions for the socket gear 15. A switch 27 located on the head allows the user to switch this drive direction for applying torque in a desired direction, changing the torque output direction on a fastener.

Referring now to FIG. 2, there is shown a perspective view of the torque transmission wrench tool of the present invention in a working position, wherein an input wrench 19 is applying a torque to the handle 11 input, thereby rotating the driveshaft of the tool, which correspondingly rotates the socket 16 within the head 13 of the tool for applying torque to a work piece or target fastener head. In this view, it is shown how the input and output rotations are related, wherein a clockwise rotation of the input establishes a clockwise rotation of the socket, while the socket may be positioned orthogonally to the input direction or at an intermediate angle thereto. The joint itself is a universal or Cardan joint, which allows misalignment of its connected shafts and further allows the user of the present tool to drive fasteners at off angles and in confined spaces.

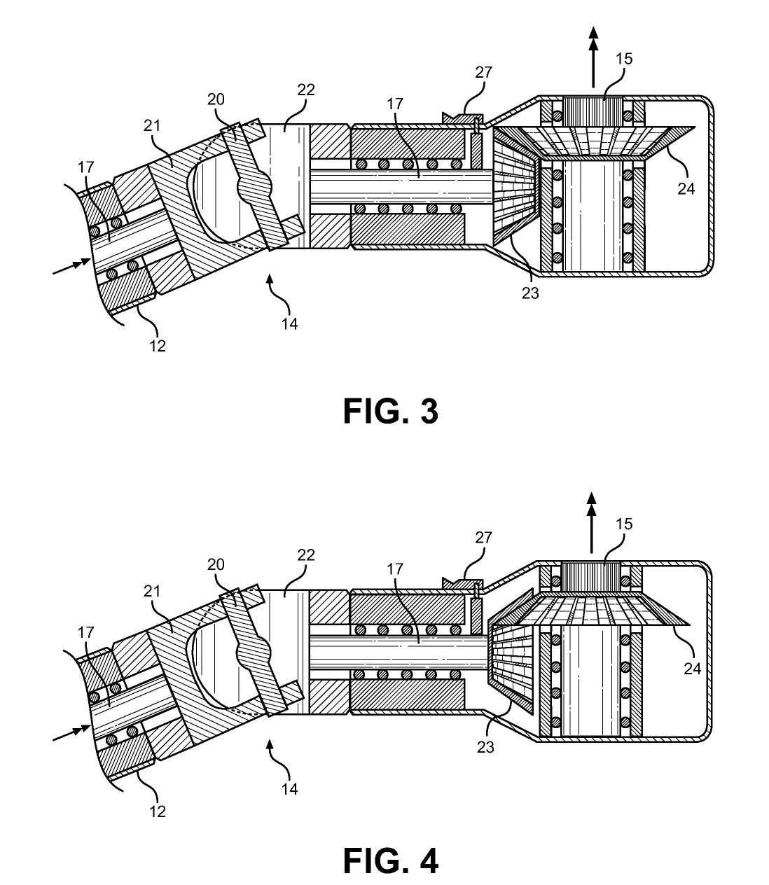

Referring now to FIG. 3, there is shown a cross sectional side view of the universal joint 14 and an embodiment of the inner mechanism utilized in the tool head to transform the universal joint input rotation into an orthogonal rotation. In this embodiment, the handle input rotation is carried by the driveshaft 17, which rotates within the handle and neck region 12 and is supported by a plurality of ball bearing assemblies. A universal joint 14 separates the driveshaft 17 into two segments, wherein a first segment is positioned within the handle and the second is within the head region and connecting to the transfer mechanism driving the socket attachment means 15. The socket attachment means is preferably a socket gear adapted to accept corresponding socket engagement teeth, or is alternatively a standard socket drive head adapted to engage a standard socket attachment. The universal joint, or Cardan joint, is one in which a pair of yokes 21, 22 are connected by a cross structure that allows angular positioning and torque transfer between the segments of the driveshaft 17, allowing the segments to be oriented at a given angle from one another. In another contemplated embodiment of the present invention, an intermediate driveshaft and second universal joint is utilized to create a constant velocity joint connection, which increases the allowable rotation of the head with respect to the handle over a single universal joint that may have a limited angular range with which rotation may be transmitted.

Within the head of the tool and just above the universal joint 14, the driveshaft extends toward a torque transfer mechanism. This mechanism is one that transforms an input rotation into a corresponding orthogonal rotation. In this way, the second segment of the driveshaft 17 inputs rotation into the head, which is then transformed into an orthogonal rotation of the socket gear 15 and installed socket therein. As shown in FIG. 3, the transfer mechanism comprises a pair of meshed bevel gears, wherein an input bevel gear 23 rotates an output bevel gear 24. The output gear 24 is attached to the socket gear along an aligned shaft within the head. As torque is applied to the input bevel gear 23, a corresponding perpendicular rotation is applied to the output bevel gear 24. In an alternate embodiment of the transfer mechanism and that shown in FIG. 4, the mechanism comprises of an internal bevel gear. Further embodiments contemplate helical, worm or any suitable gear meshing that affects an orthogonal rotation of the output with respect to the input. It is not desired to limit the present invention to a single set of dynamic components within the head of the present tool, but rather it is desired to disclose a tool having a means to alter its head position and its head having internal mechanisms to transform a driveshaft rotation into a perpendicular socket rotation.

Along the driveshaft segment 17 within the head and just prior to the transfer mechanism, a ratchet direction pawl and switch 27 is present. The ratchet pawl is adapted to allow detented rotation of the driveshaft in a given direction, wherein the given direction is alterable by way for flipping the directional switch 27 on the exterior of the tool head. The pawl engages a spur gear about the driveshaft 17 in either a clockwise or counter-clockwise direction, dictating the direction of turn and torque input direction of the driveshaft. This mechanism is common in the art of ratchet tools and would be readily recognizable to one skilled in the art for controlling the torque direction of a ratchet wrench. It is herein incorporated as a ratchet input direction means, which allows the ratcheted use of an input tool that does not inherently incorporate a ratcheting feature (such as a screw driver or standard wrench tool). For simplicity, this ratchet pawl and switch 27 may be left out of the assembly, wherein the ratchet mechanism of the input tool may be relied upon and the driveshaft may be torqued in either direction at any given time.

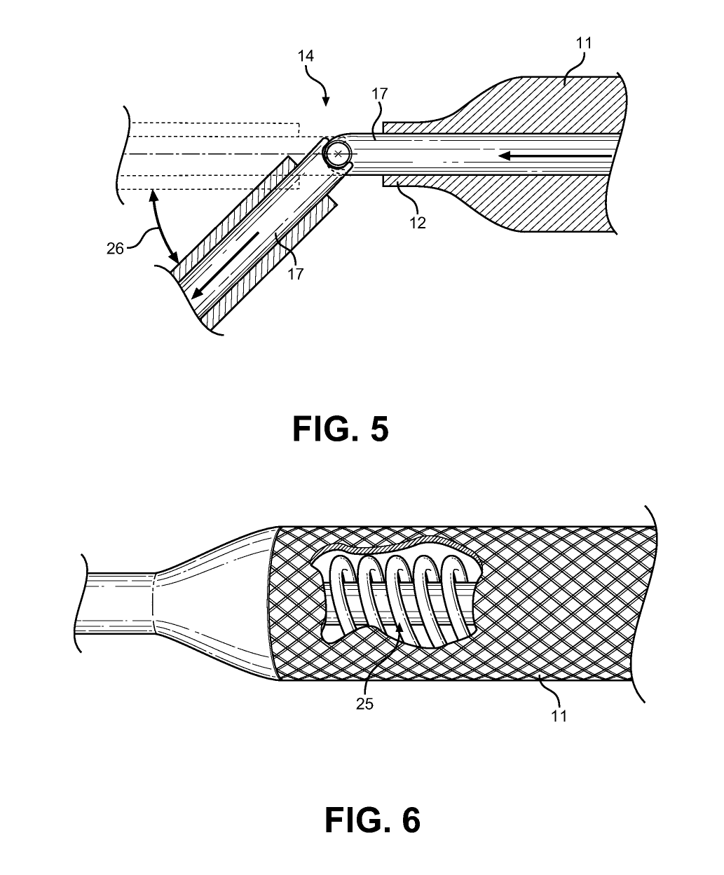

Referring to FIG. 5, there is shown a cross sectional side view of the universal joint 14 separating the segments of the driveshaft within the tool interior. The universal joint 14 comprises an exposed region between the neck 12 of the handle 11 and the head of the tool, wherein the driveshaft segments 17 are coupled to a rotating member by the driveshaft segment yokes. An angle 26 between the driveshaft segments is therefore possible while the segments rotate. The joint 14 allows a given angular offset, while a second universal joint and driveshaft segment may further be incorporated to increase this given angle by incorporating more than one joint. This alternate configuration utilizes two joints forming a constant velocity joint, which effectively doubles the allowable angle of the head with respect to the tool handle 11.

The driveshaft segments 17 are adapted to freely rotate within the handle, neck and head region of the tool, wherein a plurality of ball bearing or other suitable support members keep the shaft centrally aligned and freely rotating therein. As the driveshaft is rotated via its input, the handle, neck and head region remain stationary, while the driveshaft rotates and the socket gear undergoes a corresponding rotation. This allows the user to retain purchase of the tool handle while rotating a secondary ratchet wrench that is inputting torque into the present tool. The universal joints are preferably exposed between the neck and head regions, eliminating interferences or complex housing structures. In alternate embodiments, this region may be shrouded with a flexible cover or one that accommodates the rotational aspect of the joint in operation. The shroud may be useful for preventing dust and debris from entering the joint and hindering its operation.

Referring now to FIG. 6, there is shown a side view of the handle end of the present tool, wherein a cut-away is shown through the handle 11. In this embodiment of the present tool, a spring of an internal torque limiter mechanism is shown within the handle, which is utilized to determine when a preset torque level is achieved through the driveshaft. In this embodiment, a desired torque is input in the base of the handle by way of a rotatable member, which changes the spring compression and thus allows the user to realize when a torque is achieved by operation of the torque mechanism. This type of mechanism is well known in the art of torque mechanisms, and readily recognizable to one skilled in the art of hand tools. It is not desired to disclose a new type of torque wrench mechanism, but rather to contemplate its incorporation into an angularly adjustable torque drive wrench of the present invention.

The present invention is one that is designed to be utilized by automotive technicians and repair personnel working in confined areas or on a work piece having limited access. The device comprises a wrench drive means that accommodates a plurality of sockets and bits having an engagement region adapted to correspond with the internal teeth of the socket gear in the device head. The socket gear drives the socket, which is utilized to drive or loosen a rotary fastener. The socket gear is driven by a torque transfer gear set, which is in turn driven by a plurality of driveshaft segments coupled together by at least one universal joint. The universal joint or plurality thereof allows the head of the device to be oriented at an angle with respect to the tool handle, facilitating torque application to nuts, bolts, and fasteners in and around confined engine compartments and other crowded work piece environments. The goal is to aid users gaining access to all necessary components for the removal and installation of fasteners with relative ease and in a timely and efficient manner.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A torque transfer wrench, comprising:
a hollow handle section having a distal neck region and a torque input proximal end;
said torque input end connecting to a first rotatable driveshaft segment within said hollow handle, said driveshaft segment exiting said neck region and connecting to a second driveshaft segment via a universal joint;
rotation of said torque input is adapted to rotate said driveshaft segment;
said second driveshaft segment connecting to a head region having an internal torque transfer mechanism driving a socket attachment means in a perpendicular rotation with respect to said driveshaft rotation;
said socket attachment means adapted to accept a corresponding socket;
said head adapted to rotate with respect to said handle via said universal joint.

2) The device of claim 1, wherein said universal joint further comprises a first and second yoke attached to said first and second driveshaft segments, wherein said yokes are coupled by a cross member to allow said driveshafts to be oriented at an angle with respect to one another.

3) The device of claim 1, wherein said torque transfer means further comprises a first and second gear adapted to transform said driveshaft rotation into an orthogonal rotation of said socket attachment means.

4) The device of claim 1, wherein said socket attachment means further comprises an internal socket gear adapted to mesh with a corresponding socket.

5) The device of claim 1, wherein said socket attachment means further comprises an outwardly protruding socket drive head adapted to engage a corresponding socket.

6) The device of claim 1, wherein said hollow handle further comprises a torque limiting means to determine a preset torque limit of said driveshaft.

7) The device of claim 1, wherein said head further comprises a ratchet direction control means adapted to control said ratchet rotation direction.

8) The device of claim 1, wherein said handle torque input proximal end is adapted to accept a ratchet drive head.

9) A torque transfer wrench, comprising:
a hollow handle section having a distal neck region and a torque input proximal end;
said torque input end connecting to a first rotatable driveshaft segment within said hollow handle, said driveshaft segment exiting said neck region and connecting to at least one further driveshaft segment at least one universal joint;
rotation of said torque input is adapted to rotate said driveshaft segments;
a final driveshaft segment connecting to a head region having an internal torque transfer mechanism driving a socket attachment means in a perpendicular rotation with respect to said final driveshaft rotation;
said socket attachment means adapted to accept a corresponding socket;
said head adapted to rotate with respect to said handle via said universal joints.

10) The device of claim 9, wherein said driveshaft comprises three segments and two universal joints.

11) The device of claim 9, wherein said universal joint further comprises a first and second yoke attached to said first and second driveshaft segments, wherein said yokes are coupled by a cross member to allow said driveshafts to be oriented at an angle with respect to one another.

12) The device of claim 9, wherein said torque transfer means further comprises a first and second gear adapted to transform said driveshaft rotation into an orthogonal rotation of said socket attachment means.

13) The device of claim 9, wherein said socket attachment means further comprises an internal socket gear adapted to mesh with a corresponding socket.

14) The device of claim 9, wherein said socket attachment means further comprises an outwardly protruding socket drive head adapted to engage a corresponding socket.

15) The device of claim 9, wherein said hollow handle further comprises a torque limiting means to determine a preset torque limit of said driveshaft.

16) The device of claim 1, wherein said head further comprises a ratchet direction control means adapted to control said ratchet rotation direction.

17) The device of claim 9, wherein said handle torque input proximal end is adapted to accept a ratchet drive head.
